(19) United States
(12) Patent Application Publication
(10) Pub. No.: US 2008/0127431 A1
(43) Pub. Date: Jun. 5, 2008

(54) Water- And Acrylate-Based Flameproofing Dispersion

(76) Inventors: Andreas Harz, Providence, RI (US); Olaf Mueller, Koenigstein (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/792,775

(22) PCT Filed: Nov. 11, 2005
(86) PCT No.: PCT/EP05/12134

§ 371 Date: Jun. 8, 2007

(30) Foreign Application Priority Data
Dec. 9, 2004 (DE) 10 2004 059 221.7

(51) Int. Cl. C08K 5/49; D06M 15/19

(52) U.S. Cl. 8/490; 524/119; 524/118

(57) ABSTRACT

An aqueous dispersion which comprises a) a flame retardant of the general formula (I)

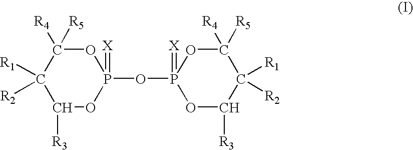

wherein R₁ represents hydrogen, C₁₋₄-alkyl, —CH₂Cl, —CH₂Br, —CH₂O—C₁₋₄-alkyl or phenyl, R₂ represents hydrogen, C₁₋₄-alkyl, —CH₂Cl, —CH₂Br or —CH₂O—C₁₋₄-alkyl, or R₁ and R₂ together with the ring carbon atoms bound to them, represent cyclohexylidene, cyclohexenylidene or 3,4-dibromocyclohexylidene, R₃ and R₅ independently represent hydrogen or C₁₋₄-alkyl, R₄ represents hydrogen or methyl, and X represents oxygen or sulfur, and b) an acrylate copolymer which substantially consists of 50 to 80 mol % of monoalkenyl aromatics and 20 to 50 mol % of acrylates. The inventive aqueous dispersions have an average molar mass Mᵥ between 1000 and 50 000 g/mol.

The present invention provides waterborne formulations of dioxaphosphorinane flame retardants, processes for their production, their use for conferring flame retardancy on natural and synthetic fibrous materials.

To achieve a satisfactory level of flame retardancy on viscose fibers, for example, the flame retardants used have to meet high requirements, in particular with regard to purity, particle fineness, storage stability, viscosity, surface tension and conductivity. Particle fineness and stability requirements in particular are very high in order that the operation of spinning fine to ultrafine denier viscose fibers of high value does not give rise to fiber and filament breakages, linear density fluctuations, fluctuations in fiber fineness or to die blockages, which are the cause of inferior quality for the end product.

Prior art flame retardant formulations as described in DE-41 28 638 A1 for example often no longer meet the requirements of the viscose industry, since they have deficiencies in fine division and thermal and storage stability, in particular with regard to recrystallization resistance.

It is an object of the present invention to provide flame retardant formulations that meet the aforementioned requirements with regard to fine division, thermal and storage stability and particularly an improved recrystallization resistance.

We have found that this object is achieved, surprisingly, when the flame retardant is dispersed with a specific, hereinbelow defined water-soluble acrylate resin, if appropriate in combination with a dispersing assistant.

The present invention accordingly provides an aqueous dispersion containing

a) a flame retardant of the general formula (I)

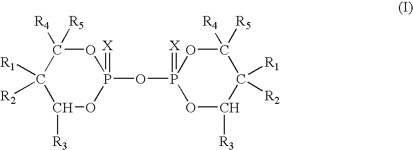

where
R₁ is hydrogen, C₁₋₄-alkyl, —CH₂Cl, —CH₂Br, —CH₂O—C₁₋₄-alkyl or phenyl,
R₂ is hydrogen, C₁₋₄-alkyl, —CH₂Cl, —CH₂Br or —CH₂O—C₁₋₄-alkyl, or
R₁ and R₂ combine with the connecting ring carbon atom to form cyclohexylidene, cyclohexenylidene or 3,4-dibromocyclohexylidene,
R₃ and R₅ are independently hydrogen or C₁₋₄-alkyl,
R₄ is hydrogen or methyl, and
X is oxygen or sulfur,
   and
   b) an acrylate copolymer consisting essentially of 50 to 80 mol % of monoalkenyl aromatics and 20 to 50 mol % of acrylates and having an average molar mass M, between 1000 and 50 000 g/mol.

The R₁ radicals are preferably methyl, ethyl, propyl, chloromethyl, bromomethyl or phenyl.

The R₂ radicals are preferably methyl, ethyl, propyl, chloromethyl or bromomethyl. A particularly preferred compound of the formula (I) conforms to the formula (Ia)

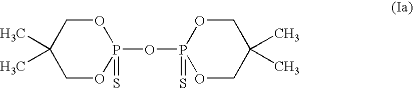

The compounds of the formula (I) and (Ia) are known and are readily obtainable in a known manner.

Monoalkenyl aromatics are in particular monomers selected from the group consisting of styrene, α-methylstyrene, vinyltoluene, tert-butylstyrene, o-chlorostyrene and also mixtures thereof.

Acrylates are monomers from the group consisting of acrylic acid, methacrylic acid, acrylic esters and methacrylic esters. Examples are:

methyl methacrylate, ethyl methacrylate, n-propyl methacrylate, n-butyl methacrylate, isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octyl methacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate.

The acrylate resin consists, preferably, of 60 to 70 mol % of monoalkenyl aromatics and 30 to 40 mol % of acrylates. Particular preference is given to acrylate resins consisting of the monomers styrene and (meth)acrylic acid.

The average molar mass, determined by gel permeation chromatography, is preferably in the range from 5000 to 25 000 g/mol. The acid number of the acrylate resin used according to the present invention is preferably between 110 and 250 and especially between 190 and 220 mg of KOH/g of acrylate resin;

the glass temperature is preferably in the range from 110 to 140° C. and especially in the range from 120 to 130° C.; the polydispersity is preferably in the range from 1.5 to 2.5 and especially in the range from 2.0 to 2.4;
the density at 25° C. is preferably in the range from 1.05 to 1.3 g/cm³ and especially in the range from 1.1 to 1.2 g/cm³;
the melting range is preferably in the range from 120 to 160° C.

The acrylate resin is advantageously used in alkaline aqueous solution or ammoniacal solution, preferably as a 1% to 35% by weight and especially as a 5% to 30% by weight solution.

The acrylate resins described above can be prepared as described in U.S. Pat. No. 4,529,787.

The acrylate resin used according to the present invention may contain in the copolymer small amounts, for example 0.5 to 2 mol %, of a surface-active compound rendered capable of an addition polymerization.

The use of the acrylate resin is sufficient to provide highly storage-stable flame retardant formulations, but the recrystallization resistance improves on addition of a further dispersing assistant of the formula (3)

R—O—(CH₂—CH₂—O)ₘ—CH₂—COOM (3),

where

### R is a C₁₀-C₂₀-alkyl radical or a C₁₀-C₂₀-alkenyl radical,

m is from 1 to 15 and

### M is a univalent cation;

or from the group of the naphthalenesulfonic acid-formaldehyde polycondensates, preferably as sodium salt, and/or from the group of the tristyrylphenol ethoxylates.

The flame retardant formulation of the present invention may further contain retention agents, preferably from the class of the α-methyl ω-hydroxy polyethylene glycol ethers having an average molar mass in the range from 250 to 1000 g/mol. Retention agents retard dispersion drying and crusting.

The dispersing agent of the formula (3) is preferably a compound in which R is C₁₂-C₁₈-alkyl or C₁₂-C₁₈-alkenyl, in particular C₁₃-C₁₆-alkyl or -alkenyl.

The number m is preferably 1 to 10.

The univalent cation M is preferably hydrogen, an alkali metal, in particular sodium, or ammonium.

Examples of compounds of the formula (3) are

### (C₁₃-C₁₅)-alkyl-O—(CH₂CH₂—O)_{9,5}—CH₂COONa,

### C₁₆H₃₃—O—(CH₂CH₂O)CH₂COONa,

### C₁₈H₃₅—O—(CH₂CH₂O)CH₂COONa,

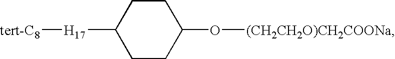

### C₁₈H₃₅—O—(CH₂CH₂O)₈—CH₂COONa,

### C₁₈H₃₇—O—(CH₂CH₂O)—CH₂COONa.

Such compounds are known from CH-A-324 665 and CH-A-283 986.

The weight ratio between the flame retardant of the formula (I) and the acrylate copolymer is preferably in the range from 1:0.1 to 1:1 and especially in the range from 1:0.15 to 1:0.5.

The preferred ratio of flame retardant and dispersant of the formula (3), if present, is in the range from 1:0.05 to 1:1 especially in the range from 1:0.05 to 1:0.5.

Preferred flame retardant formulations consist of
a) 5% to 50% by weight, preferably 20% to 45% by weight, of flame retardant of the formula (I),
b) 0.25% to 20% by weight, preferably 1% to 10% by weight, of the acrylate copolymer,
c) 0% to 12% by weight, preferably 1% to 12% by weight, and especially 2% to 8% by weight of a compound of the formula (3) and/or from the group of the naphthalenesulfonic acid-formaldehyde polycondensates and/or from the group of the tristyrylphenol ethoxylates;
d) 5% to 60% by weight, preferably 10% to 40% by weight of water,
e) 0% to 15% by weight, preferably 5% to 9% by weight, of a retention agent,
g) 0% to 10% by weight, preferably 0.5% to 9.5% by weight, of further customary additives,
   all based on the total weight of the flame retardant formulation.

Water used to produce the flame retardant formulations is preferably used in the form of distilled or ion-free water.

Further customary additives are for example preservatives, cationic, anionic or nonionic surface-active substances (surfactants and wetting agents), and also agents for regulating the viscosity, for example polyvinyl alcohol, cellulose derivatives, or water-soluble natural or artificial resins as film formers or binders to enhance the bonding strength and ruboff resistance, and also amines, for example ethanolamine, diethanolamine, triethanolamine, N,N-dimethylethanolamine or diisopropylamine, which mainly serve to raise the pH of the flame retardant formulation.

The present invention also provides a process for producing the flame retardant formulations of the present invention, which comprises finely dispersing the flame retardant in the acrylate resin solution and if appropriate the dispersing assistant of the formula (3) by means of a dispersing assembly, preferably a stirred ball mill operated at a stirrer tip speed of above 12 m/s in particular and under the action of nonmetallic grinding media not more than 1 mm in diameter, in the presence of water. The remaining additives can be present during the operation of fine dispersion and/or be added later. The acrylate resin is advantageously used as an aqueous solution, as described above. It is also possible to use an ordinary stirred ball mill, in which case however a coarser particle size distribution and a longer processing time have to be accepted.

The present invention also provides for the use of the dispersions of the present invention for finishing regenerated cellulose. The regenerated cellulose, in particular xanthate, is mixed in dissolved form, for example prior to spinning, with the dispersions of the present invention. The mixing ratio is generally between 10 and 40 parts of the flame retardant formulation of the present invention per 100 parts of pure regenerated cellulose.

The flame retardant formulations of the present invention can also be used in combination with pigments, pigment formulations and/or dyes. Addition is effected as described above for spin or solvent dyeing with simultaneous bulk flame retardant finishing or surface treatment of cellulosic materials, such as staple fibers, filaments, monofils, non wovens, sausage casings, cellophane, sponge cloths (mixtures or combinations of cellulosic and/or animal, vegetable and/or synthetic fibers), and also vegetable, animal or synthetic fibers.

The formulations of the present invention are further useful for surface coating or for bulk flame retardant finishing alone or in combination with colorants, such as pigments, pigment formulations and/or dyes, for shoe polish, candles, crayons, playdough, cosmetics, painting and dispersion colors, emulsion paints, printing colors or inks, for example textile printing colors, flexographic printing inks or gravure printing inks, for wallpapers and wallpaper colors or inks, for wood preservation systems, for lacquers, for seed, for glass bottles, for mass coloration of roof tiles, for plasters, for wood stains, for paper stocks, for colored pencil leads, felt tip pens, artists' inks, liquid inks, pastes for ballpoint pens, chalks, washing and cleaning compositions, shoe care products, latex products, abrasives and also of plastics and macromolecular materials, and also as flame retardants in electrophotographic toners and developers, for example one- or two-component powder toners, magnetic toners, liquid toners, polymerization toners and also further specialty toners, as flame retardants in ink jet inks.

The formulations of the present invention are further useful for surface coating or for bulk flame retardant finishing of articles composed for example of metal, wood, plastic, glass, ceramic, concrete, textile material, paper or rubber.

Useful colorants include organic and inorganic pigments and also polymer-soluble, partly polymer-soluble or polymer-insoluble dyes. Useful organic pigments include monoazo, disazo, laked azo, β-naphthol, naphthol AS, benzimidazolone, disazo condensation, azo metal complex pigments and polycyclic pigments such as for example phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Useful inorganic pigments include for example titanium dioxides, zinc sulfides, iron oxides, chromium oxides, ultramarine, nickel or chromium antimony titanium oxides, cobalt oxides, mixed oxides of cobalt and of aluminum, bismuth vanadates and also cut pigments.

Useful organic dyes include acid dyes, direct dyes, sulfur dyes and their leucoform, metal complex dyes or reactive dyes.

### EXAMPLES

The examples hereinbelow utilize for the acrylate solution an acrylate resin which is characterized by the following features:

Copolymer of 60-70 mol % monostyrene, 30-40 mol % acrylic acid.

Specific mass: 1150 kg/m³
Acid number: 214
Glass transition temperature: 128° C.
Molar mass: 17 250 g/mol
Melting range: 140-150° C.

### Polydispersity: 2.3

The acrylate solution itself consists of 25% by weight of the acrylate, 4% by weight of ammonia and 71% by weight of water.

### Example 1

39 parts of flame retardant of the formula (1a)

10 parts acrylate solution
2 parts of dispersant: R—O—(CH₂CH₂O)_{9,5}—CH₂COONa where R═C₁₃-C₁₅-alkyl
0.8 part of preservative
and 48.2 parts of water are homogenized using a dissolver.

Subsequently, the suspension is ground with a stirred ball mill (of the type Getzmann Dispermat) with glass grinding media, ˜1 mm diameter.

The flame retardant formulation obtained can be adjusted with water to lower active content.

The flame retardant formulation has excellent flowability, viscosity stability and very good recrystallization resistance on storage at room temperature and 50° C. for one month.

### Example 2

A formulation containing

39 parts of flame retardant of the formula (1a)
10 parts of acrylate solution
0.8 part of preservative
50.2 parts of water
is produced as described in Example 1.

### Example 3

A formulation containing

39 parts of flame retardant of the formula (1a)
10 parts of acrylate solution
6 parts of naphthalenesulfonic acid-formaldehyde polycondensate as sodium salt
0.8 part of preservative
44.2% of water
is produced as described in Example 1.

### Example 4

A formulation containing

45 parts of flame retardant of the formula (1a)
10 parts of acrylate solution
12 parts of dispersant: C₁₈H₃₅O(CH₂CH₂O)₁₂CH₂COONa
7.5 parts of α-methyl ω-hydroxy polyethylene glycol ether
0.9 part of preservative
24.6 parts of water
is produced as described in Example 1.

### Use example

15.8 parts of a dispersion produced as described in Example 1 is stirred into 200 parts of a 9% cellulose xanthate solution and spun through dies into an aqueous coagulation bath containing, per liter, 125 g of H₂SO₄, 240 g of Na₂SO₄ (anhydrous) and 12 g of ZnSO₄ (anhydrous). The filament thus obtained is thoroughly washed, dried and processed into a knit fabric. This knit fabric is subjected to a flammability test (method of Fenimorc and Martin, Modern Plastics, November 1966, or LOI value determination, ASTM D2863). A comparison with a cellulose knit not treated according to the present invention has an LOI value of about 18 for comparison, whereas the knit which has been treated according to the present invention has an LOI value of 27.5.

1) An aqueous dispersion comprising
a) a flame retardant of the formula (I) 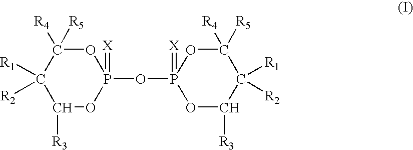
wherein
R₁ is hydrogen, C₁₋₄-alkyl, —CH₂Cl, —CH₂Br, —CH₂O—C₁₋₄-alkyl or phenyl,
R₂ is hydrogen, C₁₋₄-alkyl, —CH₂Cl, —CH₂Br or —CH₂O—C₁₋₄-alkyl, or
R₁ and R₂ combine with the connecting ring carbon atom to form cyclohexylidene, cyclohexenylidene or 3,4-dibromocyclohexylidene,
R₃ and R₅ are independently hydrogen or C₁₋₄-alkyl,
R₄ is hydrogen or methyl, and
X is oxygen or sulfur,
and
b) an acrylate copolymer consisting essentially of 50 to 80 mol % of at least one monoalkenyl aromatic and 20 to 50 mol % of at least one acrylate,
and wherein the aqueous dispersion has having an average molar mass Mᵥ between 1000 and 50 000 g/mol.

2) The dispersion according to claim 1 wherein the R₁ is methyl, ethyl, propyl, chloromethyl, bromomethyl or phenyl.

3) The dispersion according to claim 1, wherein R₂ is methyl, ethyl, propyl, chloromethyl or bromomethyl.

4) The dispersion according to claim 1, wherein the flame retardant is of the formula (Ia)

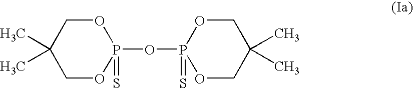

5) The dispersion according to claim 1, wherein the at acrylate copolymer is a copolymer of 60 to 70 mol % of the at least one monoalkenyl aromatic and 30 to 40 mol % of the at least one acrylate.

6) The dispersion according to claim 1, wherein the at least one monoalkenyl aromatic is a monomer selected from the group consisting of styrene, α-methylstyrene, vinyltoluene, tert-butylstyrene, o-chlorostyrene and a combination thereof.

7) The dispersion according to claim 1, wherein the at least one acrylate consists of the monomers styrene, acrylic acid, methacrylic acid or a combination thereof.

8) The dispersion according to claim 1, wherein the weight ratio between the flame retardant and the acrylate copolymer is in the range from 1:0.1 to 1:1.

9) The dispersion according to claim 1, further comprising a dispersing assistant, wherein the dispersing assistant is a naphthalenesulfonic acid-formaldehyde polycondensate, a tristyrylphenol ethoxylate, a compound of the formula (3) or a mixture thereof
R—O—(CH₂—CH₂—O)ₘ—CH₂—COOM (3),
wherein
R is a C₁₀-C₂₀-alkyl radical or a C₁₀-C₂₀-alkenyl radical,
m is from 1 to 15 and
M is a univalent cation

10) The dispersion according to claim 9, consisting of
a) 5% to 50% by weight of the flame retardant,
b) 0.25% to 20% by weight of the acrylate copolymer,
c) 0% to 12% by weight of the dispersing assistant
d) 5% to 60% by weight of water,
e) 0% to 15% by weight of a retention agent,
g) 0% to 10% by weight of at least one additive, based on the total weight of the dispersion.

11) The dispersion according to claim 9, consisting of
a) 20% to 45% by weight of the flame retardant,
b) 1% to 10% by weight of the acrylate copolymer,
c) 1% to 12% by weight of the dispersing assistant;
d) 10% to 40% by weight of water,
e) 5% to 9% by weight of a retention agent,
g) 0.5% to 9.5% by weight of at least one additive, based on the total weight of the dispersion.

12) A process for producing a dispersion according to claim 1, comprising the step of finely dispersing the flame retardant (a) in a solution of the acrylate copolymer (b) by means of a dispersing assembly in the presence of water.

13) A bulk flame retardant finishing or surface treatment composition for a cellulosic material comprising a dispersion according to claim 1.

14) A process for finishing regenerated cellulose comprising the steps of providing a regenerated cellulose in dissolved form and mixing the regenerated cellulose in dissolved form with a dispersion as claimed in claim 1.

15) A process for producing a dispersion according to claim 11, comprising the steps of finely dispersing the flame retardant (a) in a solution of the acrylate copolymer (b) and optionally one or more of the components (c), (e) and (g) by means of a dispersing assembly in the presence of water.

16) The bulk flame retardant finishing or surface treatment composition for a cellulosic material as claimed in claim 13, wherein the cellulosic material is selected from the group consisting of staple fibers, filaments, monofils, non wovens, sausage casings, cellophane, combinations of cellulosic, animal, vegetable and synthetic fibers, and vegetable, animal or synthetic fibers.

17) A finished regenerated cellulose made in accordance with the process of claim 14.
